(19) United States
(12) Patent Application Publication
(10) Pub. No.: US 2019/0210377 A1
(43) Pub. Date: Jul. 11, 2019

(54) PRINTER AND PRINTER SYSTEM

(71) Applicant: TOSHIBA TEC KABUSHIKI KAISHA, Tokyo (JP)

(72) Inventor: Yoshitaka Kuniya, Izunokuni Shizuoka (JP)

(21) Appl. No.: 16/351,608

(22) Filed: Mar. 13, 2019

Related U.S. Application Data
(62) Division of application No. 15/708,373, filed on Sep. 19, 2017.

(30) Foreign Application Priority Data
Jun. 23, 2017 (JP) 2017-123529

(51) Int. Cl. B41J 2/335; B41J 29/38; G06K 15/00; B41J 2/32

(52) U.S. Cl. CPC B41J 2/3352; B41J 2/32; G06K 15/00; B41J 29/38

(57) ABSTRACT

In accordance with an embodiment, a printer connectable to a host device comprises a printing module for carrying out printing on a medium, a reception module for receiving a first control signal for driving the printing module which is generated based on an image indicated by data which is a printing object from the host device, and a printing processing module for printing the image indicated by the data which is the printing object on the medium by driving the printing module according to the first control signal received by the reception module.

### CROSS-REFERENCE TO RELATED APPLICATIONS

This application is a Divisional of application Ser. No. 15/708,373 filed on Sep. 19, 2017, the entire contents of which are incorporated herein by reference.

This application is based upon and claims the benefit of priority from Japanese Patent Application No. P2017-123529, filed Jun. 23, 2017, the entire contents of which are incorporated herein by reference.

### FIELD

Embodiments described herein relate generally to a printer, a printer system, and methods related thereto.

### BACKGROUND

Conventionally, there exists a printer system in which a host device and a printer are connected with each other. In such a printer system, the host device converts data which is a printing object to a raster data such as a bit map, and then converts the raster data to a command to be sent to the printer. The printer decrypts the received command and executes conveyance of a paper and printing by driving a print head based on a decryption result. If the image data such as font is designated by the command, in the printer, the designated image data is read out from a memory of the printer and arranged at a designated position to execute the printing. Furthermore, in order to keep high speed of a decryption processing and various types of the image data, there exists a printer loaded with a high-speed processor and a large-capacity memory.

On the other hand, a printer having a relatively low price whose cost is suppressed as much as possible is also desired. The printer within the low price is generally loaded with a cheaper low-speed processor or relatively small storage capacity memory so as to reduce manufacturing cost. Thus, in the printer within the low price, there is a problem that processing capacity of a decryption processing or a synthesis function of the image data decreases compared with a printer within a high price.

### DESCRIPTION OF THE DRAWINGS

FIG. 1 is a diagram illustrating an example of the system structure of a printer system according to an embodiment;

FIG. 2 is a diagram illustrating an example of the hardware structure of a host device shown in FIG. 1;

FIG. 3 is a diagram schematically illustrating an example of a printing mechanism included in a printer shown in FIG. 1;

FIG. 4 is a diagram illustrating an example of the hardware structure of the printer shown in FIG. 1;

FIG. 5 is a diagram illustrating an example of the functional components of the host device and the printer shown in FIG. 1;

FIG. 6 is a diagram schematically illustrating an example of a raster data; and

FIG. 7 is a flowchart illustrating an example of a printing processing executed by the host device and the printer according to the present embodiment.

### DETAILED DESCRIPTION

In accordance with an embodiment, a printer capable of being connected to a host device comprises a printing module for carrying out printing on a medium, a reception module for receiving a first control signal for driving the printing module which is generated based on an image indicated by data which is a printing object from the host device, and a printing processing module for printing the image indicated by the data which is the printing object on the medium by driving the printing module according to the first control signal received by the reception module.

In accordance with another embodiment, a printing method involving a printer and a separate host device involves receiving a first control signal for driving a printing job, the first control signal being generated based on an image indicated by data of a printing object from the host device; and printing the image indicated by the data of the printing object on the medium by driving the printing job according to the first control signal received.

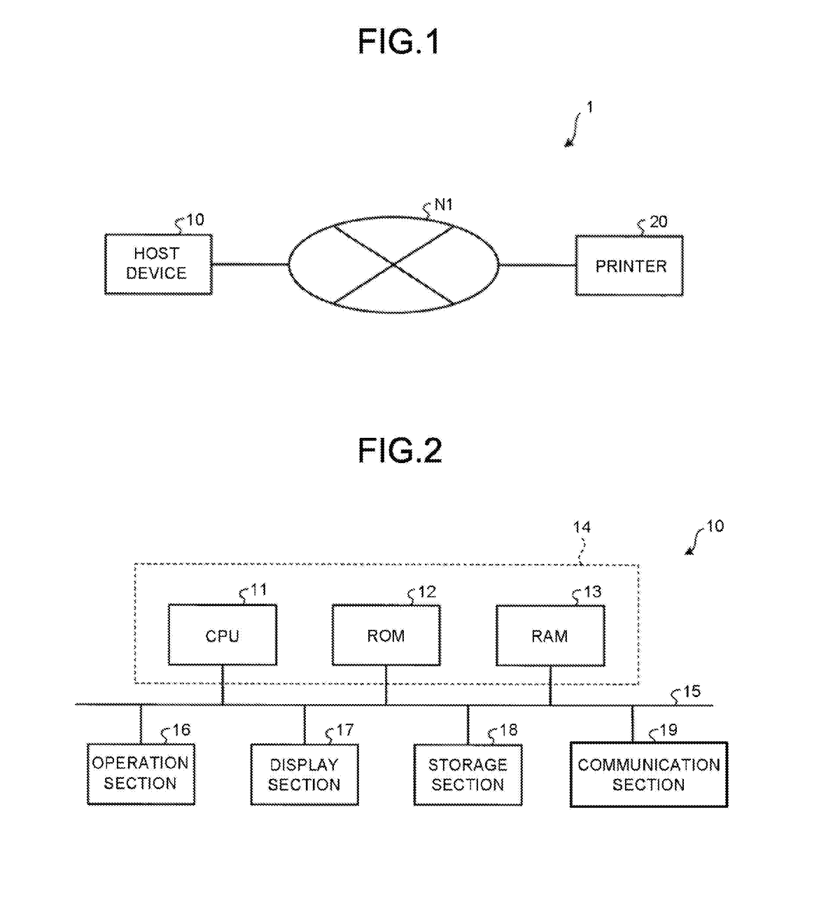

FIG. 1 is a diagram illustrating an example of the system structure of a printer system according to an embodiment. As shown in FIG. 1, the printer system 1 has a host device 10 and a printer 20. The host device 10 and the printer 20 are communicably connected via a network N1 such as a LAN (Local Area Network). The number of the host device 10 and the printer 20 connected to the network N1 is not particularly limited. The host device 10 and the printer 20 may be directly connected by a serial cable or the like.

The host device 10 is an information processing device such as a PC (Personal Computer) or a POS terminal (Point Of Sales system). The host device 10 executes various processing according to the operation by an operator. If printing is instructed by the operator, the host device 10 cooperates with the printer 20 to print data which is a printing object.

The printer 20 is an example of the printer (printing device). The printer 20 is connected to the host device 10 via the network N1 and executes printing on a predetermined paper based on an instruction from the host device 10. The printing method and mechanism of the printer 20 are not particularly limited. In the present embodiment, an example is described in which a thermal type thermal printer that executes printing of a barcode or the like on a thermal paper by heat is used as the printer 20.

FIG. 2 is a diagram illustrating an example of the hardware structure of the host device 10. As shown in FIG. 2, the host device 10 is provided with a controller 14 of a computer constitution including a CPU (Central Processing Unit) 11, a ROM (Read Only Memory) 12, a RAM (Random Access Memory) 13 and the like.

The CPU 11 is a processor and collectively controls the operation of the host device 10. The ROM 12 stores various programs executed by the CPU 11 and control information. The RAM 13 functions as a work area of the CPU 11.

An operation section 16, a display section 17, a storage section 18, and a communication section 19 are connected to the CPU 11 via a bus line 15.

The operation section 16 has various input devices such as a keyboard and a pointing device for an operator to execute operation input. The CPU 11 receives the operation input by the operator via the operation section 16.

The display section 17 has a display device such as a liquid crystal display. The display section 17 displays various information and screens on the display device under the control of the CPU 11. The display section 17 may have a touch panel constitution. In this case, the touch panel of the display section 17 functions as the operation section 16.

The storage section 18 is an auxiliary storage device such as an HDD (Hard Disk Drive) or an SSD (Solid State Drive), for example. The storage section 18 stores various programs executed by the CPU 11 and setting information. For example, the storage section 18 stores a program such as a device driver relating to a printing control by the printer 20. The storage section 18 stores the setting information relating to specifications and characteristics of the printer 20 (a print head 204, a conveyance section 26 and the like described later). The storage section 18 stores the image data such as a font which can be used for printing.

The communication section 19 is a wired or wireless communication interface connectable to the network N1. The communication section 19 is able to execute communication with the printer 20 connected to the network N1.

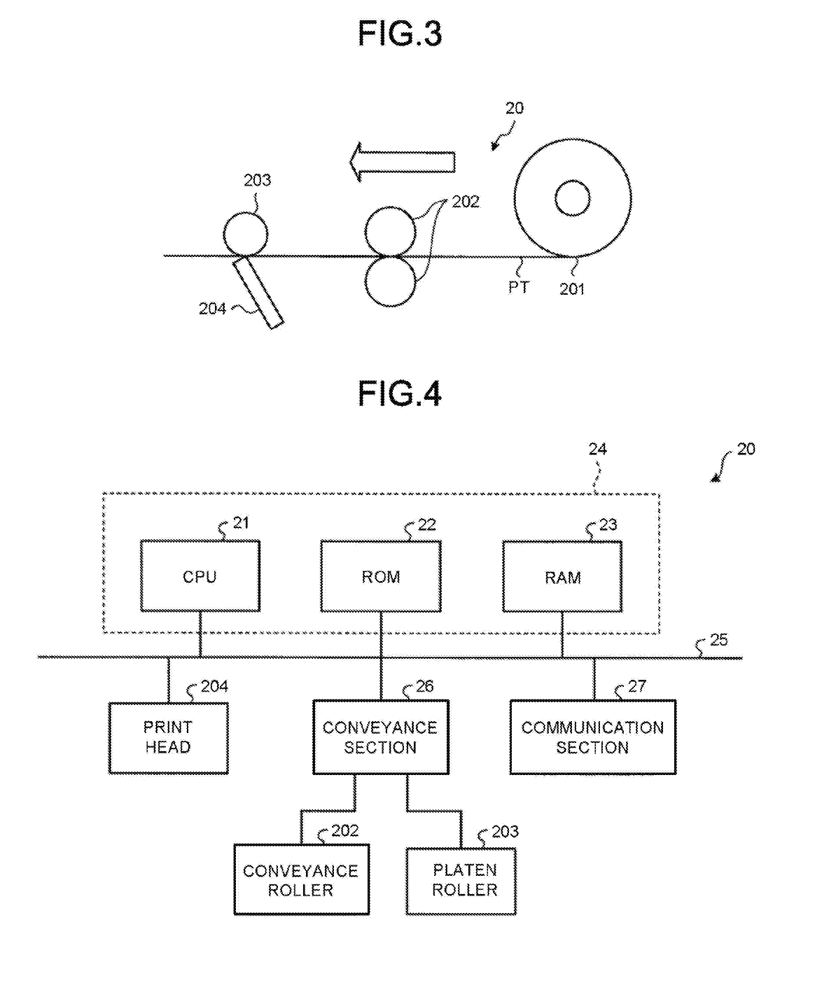

Next, the printer 20 is described. FIG. 3 is a diagram schematically illustrating an example of a printing mechanism included in the printer 20. As shown in FIG. 3, the printer 20 includes a paper housing section 201, a conveyance roller 202, a platen roller 203 and the print head 204.

The paper housing section 201 houses a paper PT. The paper PT is formed by winding a thermal paper which is a medium in a roll shape.

The conveyance roller 202 is arranged on a conveyance path of the paper PT and rotationally driven by the conveyance section 26 (refer to FIG. 4). The conveyance roller 202 draws out the paper PT from the paper housing section 201 and conveys it in a direction of an arrow in FIG. 3 in which the print head 204 exists.

The platen roller 203 is arranged on the conveyance path of the paper PT and rotationally driven by the conveyance section 26 (refer to FIG. 4). The platen roller 203 conveys the paper PT towards a paper discharge port (not shown).

The print head 204 is an example of a printing module and is arranged to face the platen roller 203. The print head 204 has a number of heat generation elements (not shown) arranged linearly in a direction orthogonal to the conveyance direction of the paper PT. The print head 204 prints characters and figures on the conveyed paper PT by enabling the heat generation element to generate heat based on an instruction signal input from a CPU 21 (refer to FIG. 4).

FIG. 4 is a diagram illustrating an example of the hardware structure of the printer 20. As shown in FIG. 4, the printer includes a controller 24 having a computer structure constituted by the CPU 21, a ROM 22 and a RAM 23 in addition to the conveyance roller 202, the platen roller 203 and the print head 204 described above.

The CPU 21 is a processor and collectively controls the operation of the printer 20. The ROM 22 stores various programs executed by the CPU 21 and control information. The RAM 23 functions as a work area of the CPU 21.

The conveyance section 26, a communication section 27, and the like are connected to the CPU 21 via a bus line 25. The conveyance section 26 is an example of a convey module. The conveyance section 26 includes a driving source such as a stepping motor of the conveyance roller 202 and the platen roller 203. The conveyance section 26 rotationally drives the conveyance roller 202 and the platen roller 203 in accordance with a conveyance control signal input from the CPU 21 so that the paper PT housed in the paper housing section 201 is conveyed on the conveyance path.

The communication section 27 is a wired or wireless communication interface connectable to the network N1. The communication section 27 is able to execute communication with the host device 10 connected to the network N1.

The characteristic functions of the host device 10 and the printer 20 are described. FIG. 5 is a diagram illustrating an example of the functional components of the host device 10 and the printer 20.

As shown in FIG. 5, the CPU 11 of the host device 10 operates according to the program stored in the ROM 12 and the storage section 18 to function as a raster data generation section 111, a printing control signal generation section 112, a conveyance control signal generation section 113 and a control signal transmission section 114 as functional sections.

The raster data generation section 111 generates the raster data in a page unit by converting the data which is the printing object to a bit map or the like. Here, the term “page unit” means an image range that can be accommodated in a single plane. For example, the page unit may be set based on a paper size such as A4 size or B4 size. The raster data generation section 111 reads the designated image data from the storage section 18 if the image data such as the font is designated in the data which is the printing object, and generates the raster data in which the image data is arranged (synthesized) at the designated position and size.

The raster data generation section 111 generates the raster data corresponding to the specification and characteristics of the printer 20 based on the setting information of the printer 20 stored in the storage section 18 and the like. For example, the raster data generation section 111 generates the raster data with a resolution corresponding to the number of the heat generation elements of the print head 204.

The printing control signal generation section 112 generates a pulse signal (hereinafter referred to as a printing control signal) for driving the print head 204 of the printer 20 based on the image represented by the data (raster data) which is the printing object. Specifically, the printing control signal generation section 112 generates the printing control signal for turning on/off each heat generation element of the print head 204 in the line unit which is the printing unit in the printer 20 based on a pixel value of each pixel constituting the raster data.

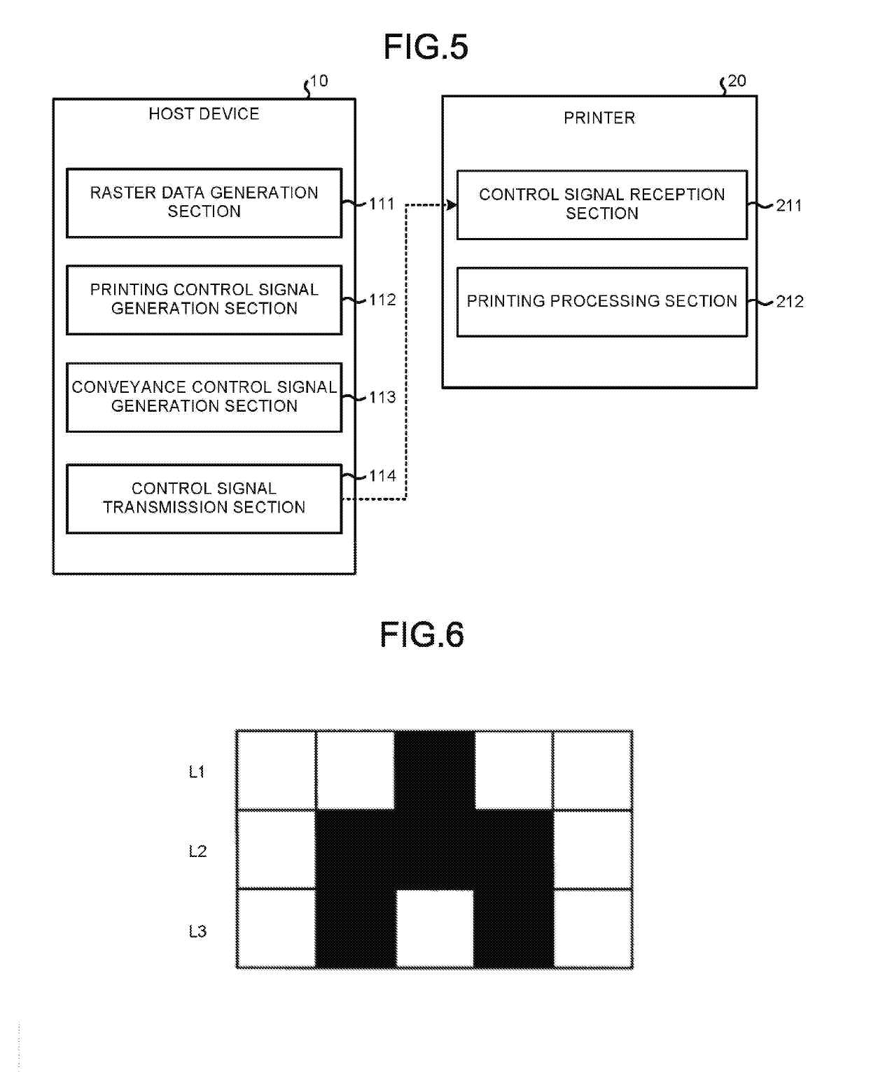

FIG. 6 is a diagram schematically illustrating an example of the raster data. The raster data shown in FIG. 6 is composed of 3 lines of L1 to L3, and the number of pixels constituting each line corresponds to the number of the heat generation elements of the print head 204. The print head 204 of the printer 20 prints in the line unit of the lines L1 to L3. In the raster data in FIG. 6, the printing is executed in the order of the lines L1 to L3.

In FIG. 6, if a thermal paper that turns black by heating is used, the printing control signal generation section 112 generates the printing control signal for turning off the energization of the heat generation element corresponding to the white pixel and turning on the energization of the heat generation element corresponding to the black pixel for each line of the lines L1 to L3. For example, if a state of turning off the energization is represented by “0” and a state of turning on the energization is represented by “1”, the printing control signal generation section 112 generates a printing control signal indicating “00100” for the line L1. The printing control signal generation section 112 generates a printing control signal indicating “01110” for the line L2 and generates a printing control signal indicating “01010” for the line L3. The printing control signal generation section 112 may generate the printing control signal considering a thermal history of the print head 204 by using a known technology relating to the thermal history.

Returning to FIG. 5, the conveyance control signal generation section 113 generates a pulse signal (hereinafter referred to as a conveyance control signal) for driving the conveyance section 26 of the printer 20 based on the raster data generated by the raster data generation section 111. Specifically, the conveyance control signal generation section 113 generates a conveyance control signal instructing to convey the paper PT on the conveyance path. For example, the conveyance control signal generation section 113 determines conditions such as a conveyance speed and a conveyance interval of the paper PT based on the specification of the printer 20 and the state of the raster data stored in the storage section 18 to generate a conveyance control signal according to the condition. The conveyance speed and conveyance interval are not limited to certain values but may be variable according to a size of a margin part included in the raster data, for example.

In cooperation with the communication section 19, the control signal transmission section 114 transmits the printing control signal and the conveyance control signal generated respectively by the printing control signal generation section 112 and the conveyance control signal generation section 113 to the printer 20.

The control signal transmission section 114 may transmit the printing control signal and the conveyance control signal synchronously so that the printing operation by the print head 204 cooperates with the conveyance operation of the paper PT by the conveyance section 26. For example, the control signal transmission section 114 may transmit the printing control signal and the conveyance control signal by adjusting a timing thereof in such a manner that a timing of energization by the printing control signal is set to a timing immediately after conveying the paper PT corresponding to one line by the conveyance control signal. A synchronization method of the printing control signal and the conveyance control signal can use a known technology relating to the printing control.

The control signal transmission section 114 may temporarily hold the generated printing control signal and conveyance control signal in the RAM 13 or the like, and may transmit the printing control signal and the conveyance control signal in the page unit or the line unit. The control signal transmission section 114 may also transmit the signals including a signal for synchronizing the printing control signal and the conveyance control signal.

On the other hand, the CPU 21 of the printer 20 operates according to the program stored in the ROM 22, as shown in FIG. 5, to function as a control signal reception section 211 and a printing processing section 212.

The control signal reception section 211 is an example of a reception module. The control signal reception section 211 receives the printing control signal and the conveyance control signal transmitted from the host device 10 (the control signal transmission section 114) in cooperation with the communication section 27. The control signal reception section 211 holds the received printing control signal and conveyance control signal in the RAM 23.

The printing processing section 212 is an example of a printing processing module. The printing processing section 212 drives the print head 204 and the conveyance section 26 according to the printing control signal and the conveyance control signal received by the control signal reception section 211 to execute a printing processing for printing the data which is the printing object. Furthermore, the printing control signal received by the control signal reception section 211 is input to the print head 204. The printing processing section 212 inputs the conveyance control signal received by the control signal reception section 211 to the conveyance section 26.

The conveyance section 26 conveys the paper PT on the conveyance path by driving the driving source of the conveyance roller 202 and the platen roller 203 based on the conveyance control signal input from the printing processing section 212. The print head 204 drives the heat generation element (generate heat) based on the conveyance control signal input from the printing processing section 212 to print the image such as characters or figures represented by the raster data on the paper PT.

There are no particular restrictions on start method of the printing processing, and various forms are possible. For example, the printing processing section 212 may read the printing control signal and the conveyance control signal from the RAM 23 in the page unit or the line unit to execute the printing processing. The printing processing section 212 may execute the printing processing in real time while enabling the control signal receiving section 211 to receive the printing control signal and the conveyance control signal.

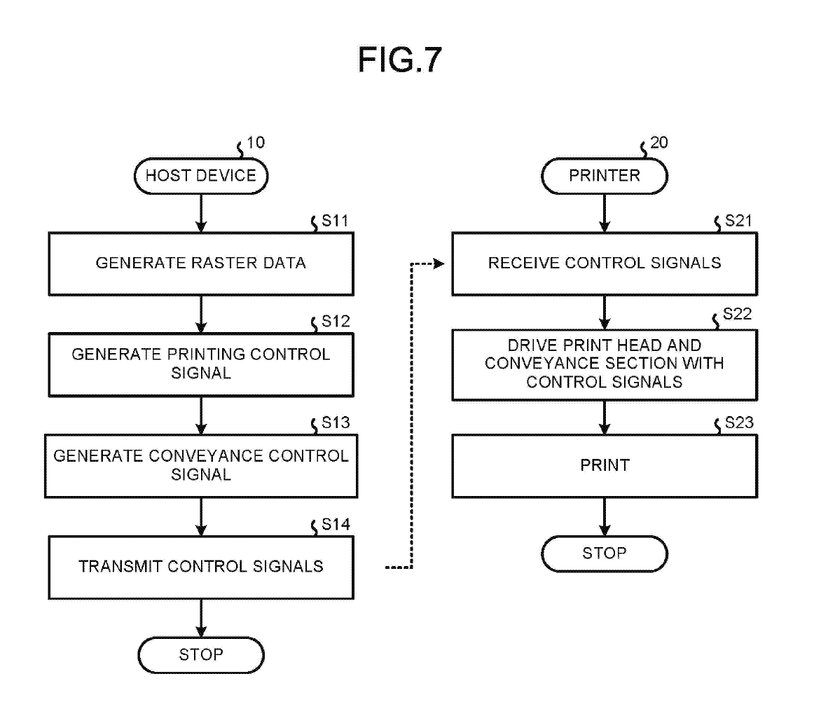

Hereinafter, the operations of the host device 10 and the printer 20 are described. FIG. 7 is a flowchart illustrating an example of the printing processing executed by the host device 10 and the printer 20.

The raster data generation section 111 of the host device 10 generates the raster data by converting the data such as a document or image which is the printing object (Act S11). The data which is the printing object may be generated (created) by the host device 10 or may be input from an external device (not shown) via the network N1.

The printing control signal generation section 112 of the host device 10 generates the printing control signal for driving the print head 204 of the printer 20 based on the raster data generated in Act S11 (Act S12). The conveyance control signal generation section 113 of the host device 10 generates the conveyance control signal for driving the conveyance section 26 of the printer 20 (Act S13). Next, the control signal transmission section 114 of the host device 10 transmits the generated printing control signal and conveyance control signal to the printer 20 (Act S14).

On the other hand, in the printer 20, the control signal reception section 211 receives the printing control signal and the conveyance control signal transmitted from the host device 10 (Act S21). The printing processing section 212 of the printer 20 drives the print head 204 and the conveyance section 26 according to the printing control signal and the conveyance control signal received in Act S21 (Act S22). The print head 204 and the conveyance section 26 are driven based on the printing control signal and the conveyance control signal to print the image represented by the data (the raster data) which is the printing object on the paper PT (Act S23), and the present processing is terminated.

As described above, according to the printer system 1 of the present embodiment, based on the image represented by the data (the raster data) which is the printing object, the host device 10 generates the printing control signal for driving the print head 204 of the printer 20 to transmit the printing control signal to the printer 20. On the other hand, the printer 20 prints the image indicated by the data which is the printing object on the paper PT by driving the print head 204 using the printing control signal transmitted from the host device 10 as it is.

As described above, in the printer system 1 of the present embodiment, an arithmetic processing during printing such as a command decoding is not necessary in the printer 20. As a result, since the CPU 21 mounted on the printer 20 can be an inexpensive processor with low processing capability, manufacturing cost associated with the printer 20 can be reduced.

In the printer system 1 of the present embodiment, since synthesis of the image data such as fonts is executed at the host device 10 side, it is unnecessary to hold the image data at the printer 20 side. Thus, as the ROM 22 mounted on the printer 20 can be the inexpensive memory with a low storage capacity, the manufacturing cost of the printer 20 can be reduced.

Furthermore, in the printer system 1 of the present embodiment, since the host device 10 is responsible for the processing such as synthesis of the image data, even if the printer 20 within a low price range is provided with a low-speed processor and a memory with a low storage capacity, the processing capacity can be easily improved. In particular, in the information processing devices such as a PC, it is common to install the high-performance processor and memory compared with those installed in the printer, so that the processing capacity can be improved.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the above-described embodiment, the printing control signal and the conveyance control signal are transmitted from the host device 10 to the printer 20, but the present invention is not limited thereto, and only the printing control signal may be transmitted. In this case, the controller 24 (CPU 21) of the printer 20 generates the conveyance control signal for conveying the paper PT based on the printing control signal transmitted from the host device 10 to input it to the conveyance section 26.

In the above embodiment, an example in which the printing control signal and the conveyance control signal are synchronized at the host device 10 side is described. However, the present invention is not limited thereto and may be executed at the printer 20 side. In this case, the printing processing section 212 of the printer 20 synchronizes the printing control signal with the conveyance control signal so that the printing operation by the print head 204 cooperates with the conveyance operation of the paper PT by the conveyance section 26 and input them to the print head 204 and the conveyance section 26. The printing control signal and the conveyance control signal can be synchronized using a known technology relating to the printing control.

In the above embodiment, the printer 20 is the thermal printer, but the present invention is not limited thereto, and the printer 20 may be applied to printers of other printing methods. For example, the printer 20 may be applied to a laser printer and an ink jet printer.

In the above embodiment, as the thermal printer, a thermal type printer which executes printing on the thermal paper is described; however, the printer may be applied to a thermal transfer type printer in which the printing is executed using an ink ribbon. In the case of the thermal transfer type printer, the host device 10 controls the printing operation by the thermal transfer type printer by transmitting a control signal for driving the conveyance mechanism of the paper and the ink ribbon and the print head based on the image represented by the data (the raster data) which is the printing object. If the thermal transfer type printer has a function of lifting the print head 204, the host device 10 may transmit the control signal for controlling an elevation amount of the print head 204 to the thermal transfer type printer according to the image represented by the data (the raster data) which is the printing object. The host device 10 may execute a ribbon save process for controlling the feed amount of the ink ribbon according to the image represented by the data (the raster data) which is the printing object.

In the above embodiment, the printer 20 may execute the printing according to the control signal from the host device 10, but various operations (hereinafter, referred to as accompanying operations) incidental to printing are executed at the printer 20 side. The accompanying operation is, for example, an alignment of the papers PT, the detection of the paper out of the paper PT and a notice thereon. In this case, the CPU 21 of the printer 20 executes the accompanying operation based on sensing results of various sensors (not shown) provided on the conveyance path.

The above-described accompanying operation may be controlled at the host device 10 side. In this case, the controller 24 (CPU 21) of the printer 20 transmits the sensing result of the various sensors provided in the printer 20 to the host device 10. On the other hand, the controller 14 (CPU 11) of the host device 10 determines the state of the printer 20 based on the sensing result of the printer 20. The controller 14 of the host device 10 controls the operation of the printer 20 so as to execute the accompanying operation according to the state of the printer 20. For example, the host device 10 executes the alignment of the paper PT by driving the conveyance section 26 of the printer 20. For example, if the host device 10 transmits the control signal to the printer 20 to drive a notification device (not shown) such as an indicator lamp equipped in the printer 20 if detecting the paper out of the paper PT to notify the notification to the printer 20.

The programs executed by each device of the foregoing embodiment may be incorporated into a storage medium (ROM or HDD) of each device to be provided; however, the present invention is not limited to this. The programs may be recorded in a computer-readable recording medium such as a CD-ROM, a FD (Flexible Disk), a CD-R, a DVD (Digital Versatile Disk) and the like in the form of installable or executable file to be provided. Further, the storage medium is not limited to a medium independent from a computer or an embedded system and also contains a storage medium that stores or temporarily stores the programs by downloading the programs transmitted via a LAN or an Internet.

Further, the programs executed by each device of the foregoing embodiment maybe stored in a computer connected with a network such as Internet and downloaded via the network to be supplied or may be supplied or distributed via the network such as the Internet.

What is claimed is:

1. A printing method involving a printer and a separate host device, comprising:
receiving a first control signal for driving a printing job, the first control signal being generated based on an image indicated by data of a printing object from the host device; and
printing the image indicated by the data of the printing object on the medium by driving the printing job according to the first control signal received.

2. The printing method according to claim 1, further comprising:
conveying the medium on a conveyance path, wherein
executing printing on the medium conveyed by the conveyance device,
receiving a second control signal for driving the medium on the conveyance path together with the first control signal from the host device, and
driving the medium with the second control signal to convey the medium on the conveyance path.

3. The printing method according to claim 1, further comprising:
holding the first control signal received; and
reading the first control signal in a predetermined unit.

4. The printing method according to claim 2, further comprising:
holding the first control signal received; and
reading the first control signal in a predetermined unit.

5. The printing method according to claim 1, further comprising:
receiving the first control signal while driving the printing job according to the first control signal.

6. The printing method according to claim 1, further comprising:
receiving the first control signal for instructing an energization state of each heat generation element in a line unit of a thermal head based on the image indicated by the data of the printing object; and
driving the thermal head according to the first control signal received.

7. A printing method involving a printer and a separate host device, comprising:
receiving a first control signal for driving a printing job, the first control signal being generated based on an image indicated by data of a printing object from the host device;
printing the image indicated by the data of the printing object on the medium by driving the printing job according to the first control signal received;
conveying the medium on a conveyance path;
receiving a second control signal for driving the medium on the conveyance path together with the first control signal from the host device; and
driving the medium with the second control signal to convey the medium on the conveyance path.

8. The printing method according to claim 7, further comprising:
holding the first control signal received; and
reading the first control signal in a predetermined unit.

9. The printing method according to claim 7, further comprising:
holding the first control signal received; and
reading the first control signal in a predetermined unit.

10. The printing method according to claim 7, further comprising:
receiving the first control signal while driving the printing job according to the first control signal.

11. The printing method according to claim 7, further comprising:
receiving the first control signal for instructing an energization state of each heat generation element in a line unit of a thermal head based on the image indicated by the data of the printing object; and
driving the thermal head according to the first control signal received.

12. A printing method involving a host device and a printer, comprising:
generating a first control signal for driving the printer based on an image indicated by data of a printing object;
transmitting the first control signal to the printer;
receiving the first control signal from the host device; and
printing the image indicated by the data of the printing object on a medium by driving the printer according to the first control signal received.

13. The printing method according to claim 12, further comprising:
conveying the medium on a conveyance path, wherein printing is executed on the medium conveyed;
receiving a second control signal for conveying with the first control signal from the host device; and
using the second control signal to convey the medium on the conveyance path.

14. The printing method according to claim 12, further comprising:
holding the first control signal received; and
printing by reading the first control signal from the holding module in a predetermined unit.

15. The printing method according to claim 13, further comprising:
holding the first control signal received by the reception module; and
driving the printer by reading the first control signal in a predetermined unit.

16. The printing method according to claim 12, wherein
a printing processing module receives the first control signal with the reception module while driving the printing device according to the first control signal.

17. The printing method according to claim 12, wherein
the printer comprises a thermal head having a plurality of heat generation elements linearly arranged, a reception module receives the first control signal for instructing an energization state of each heat generation element generated in a line unit of the heat generation element based on the image indicated by the data of the printing object, and
a printing processing module drives the thermal head according to the first control signal received by the reception module.

18. The printing method according to claim 12, wherein
the host device comprises a personal computer or a point of sales system.
